(19) United States
(12) Patent Application Publication
(10) Pub. No.: US 2026/0238635 A1
(43) Pub. Date: Aug. 13, 2026

(54) DELEGATED DATA RETRIEVAL USING AGENTIC PROMPT PROCESSING UNITS

(71) Applicant: Cisco Technology, Inc., San Jose, CA (US)

(72) Inventors: Marcelo Yannuzzi, Nuvilly (CH); Jean Andrei Diaconu, Gaillard (FR); Hervé Muyal, Gland, Vaud (CH); Arash Salarian, Chardonne (CH)

(73) Assignee: Cisco Technology, Inc., San Jose, CA (US)

(21) Appl. No.: 19/262,622

(22) Filed: Jul. 8, 2025

Related U.S. Application Data
(60) Provisional application No. 63/757,452, filed on Feb. 12, 2025.

(51) Int. Cl. H04L 9/40

(52) U.S. Cl. CPC H04L 63/083

(57) ABSTRACT

In one implementation, a device may parse a prompt to be submitted to a language model to identify data being requested by the prompt, functions associated with retrieving the data, and an access token carrying a corresponding identity of a requestor of the prompt. The device may perform an authorization lookup in an identity and access management matrix that contains a solution for a delegated authorization chain using the access token and the functions associated with retrieving the data. The device may retrieve, responsive to a successful authorization lookup, the data being requested by the prompt using a plan formulated based on the solution for the delegated authorization chain. The device may send the prompt and retrieved data to the language model to prepare a response to the requestor of the prompt.

### RELATED APPLICATION

This application claims priority to U.S. Prov. Appl. Ser. No. 63/757,452, filed Feb. 12, 2025, entitled DELEGATED DATA RETRIEVAL USING AGENTIC PROMPT PROCESSING UNITS, by Yannuzzi, et al., the contents of which are incorporated herein by reference.

### TECHNICAL FIELD

The present disclosure relates generally to computer networks, and, more particularly, to delegated data retrieval using agentic prompt processing units.

### BACKGROUND

The recent breakthroughs in large language models (LLMs) represent new opportunities across a wide spectrum of industries. More specifically, the ability of new models to follow instructions now allows for interactions with tools that can perform tasks such as searching the web, executing code, etc. In addition, agents can be developed to perform complex tasks and workflows by chaining multiple calls to one or more LLMs.

The capacity of these agents to automatically identify, search, retrieve, and use enterprise data as part of complex workflows will be key to their adoption and success. However, this poses complex challenges for enterprises, since existing Identity Provider (IdP) systems, Authentication (AuthN) and Authorization (AuthZ) protocols and servers, and Active Directory (AD) systems fall short while trying to delegate and authorize automated data retrievals performed by headless agents.

### BRIEF DESCRIPTION OF THE DRAWINGS

The implementations herein may be better understood by referring to the following description in conjunction with the accompanying drawings in which like reference numerals indicate identically or functionally similar elements, of which:

FIG. 1 illustrates an example computing system;

FIG. 2 illustrates an example network device/node;

FIG. 3 illustrates an example of an architecture for sending prompts to a remote language model;

FIG. 4 illustrates an example of an architecture utilizing prompt processing units;

FIG. 5 illustrates an example of an environment within which enterprise data may be utilized as part of complex workflows;

FIG. 6 illustrates an example of an environment with an incorporated system to facilitate delegated data retrieval;

FIG. 7 illustrates an example of a system for solving a delegated AuthZ chain using IAM matrices;

FIG. 8 illustrates an example of a simplified procedure for populating and approving an IAM matrix enabling automated delegated AuthZ chain resolution; and

FIG. 9 illustrates an example of a simplified procedure for delegated data retrieval using agentic prompt processing units, in accordance with one or more implementations described herein.

### DESCRIPTION OF EXAMPLE IMPLEMENTATIONS

### Overview

According to one or more implementations of the disclosure, a device may parse a prompt to be submitted to a language model to identify data being requested by the prompt, functions associated with retrieving the data, and an access token carrying a corresponding identity of a requestor of the prompt. The device may perform an authorization lookup in an identity and access management matrix that contains a solution for a delegated authorization chain using the access token and the functions associated with retrieving the data. The device may retrieve, responsive to a successful authorization lookup, the data being requested by the prompt using a plan formulated based on the solution for the delegated authorization chain. The device may send the prompt and retrieved data to the language model to prepare a response to the requestor of the prompt.

Other implementations are described below, and this overview is not meant to limit the scope of the present disclosure.

### Description

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. The Internet is an example of a WAN that connects disparate networks throughout the world, providing global communication between nodes on various networks. Other types of networks, such as field area networks (FANs), neighborhood area networks (NANs), personal area networks (PANs), enterprise networks, etc. may also make up the components of any given computer network. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

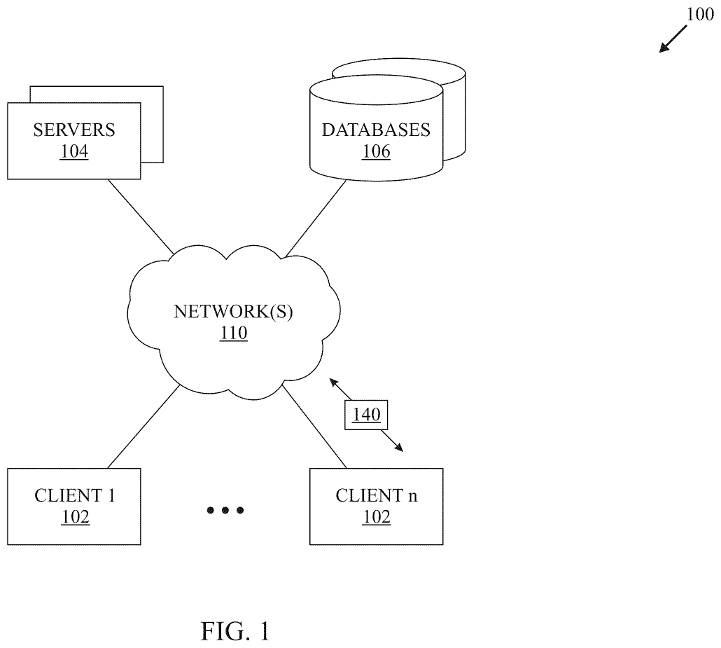

FIG. 1 is a schematic block diagram of an example simplified computing system (e.g., computing system 100) illustratively comprising any number of client devices (e.g., client devices 102 with, e.g., a first through nth client device), one or more servers (e.g., servers 104), and one or more databases (e.g., databases 106), where the devices may be in communication with one another via any number of networks (e.g., network(s) 110). The one or more networks (e.g., network(s) 110) may include, as would be appreciated, any number of specialized networking devices such as routers, switches, access points, etc., interconnected via wired and/or wireless connections. For example, devices 102-104 and/or the intermediary devices in network(s) 110 may communicate wirelessly via links based on WiFi, cellular, infrared, radio, near-field communication, satellite, or the like. Other such connections may use hardwired links, e.g., Ethernet, fiber optic, etc. The nodes/devices typically communicate over the network by exchanging discrete frames or packets of data (packets 140) according to predefined protocols, such as the Transmission Control Protocol/Internet Protocol (TCP/IP) other suitable data structures, protocols, and/or signals. In this context, a protocol consists of a set of rules defining how the nodes interact with each other.

Client devices 102 may include any number of user devices or end point devices configured to interface with the techniques herein. For example, client devices 102 may include, but are not limited to, desktop computers, laptop computers, tablet devices, smart phones, wearable devices (e.g., heads up devices, smart watches, etc.), set-top devices, smart televisions, Internet of Things (IoT) devices, autonomous devices, or any other form of computing device capable of participating with other devices via network(s) 110.

Notably, in some implementations, servers 104 and/or databases 106, including any number of other suitable devices (e.g., firewalls, gateways, and so on) may be part of a cloud-based service. In such cases, servers 104 and/or databases 106 may represent the cloud-based device(s) that provide certain services described herein, and may be distributed, localized (e.g., on the premise of an enterprise, or “on prem”), or any combination of suitable configurations, as will be understood in the art.

Those skilled in the art will also understand that any number of nodes, devices, links, etc. may be used in computing system 100, and that the view shown herein is for simplicity. Also, those skilled in the art will further understand that while the network is shown in a certain orientation, the computing system 100 is merely an example illustration that is not meant to limit the disclosure.

Notably, web services can be used to provide communications between electronic and/or computing devices over a network, such as the Internet. A web site is an example of a type of web service. A web site is typically a set of related web pages that can be served from a web domain. A web site can be hosted on a web server. A publicly accessible web site can generally be accessed via a network, such as the Internet. The publicly accessible collection of web sites is generally referred to as the World Wide Web (WWW).

Also, cloud computing generally refers to the use of computing resources (e.g., hardware and software) that are delivered as a service over a network (e.g., typically, the Internet). Cloud computing includes using remote services to provide a user's data, software, and computation.

Moreover, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a Software as a Service (SaaS) over a network, such as the Internet.

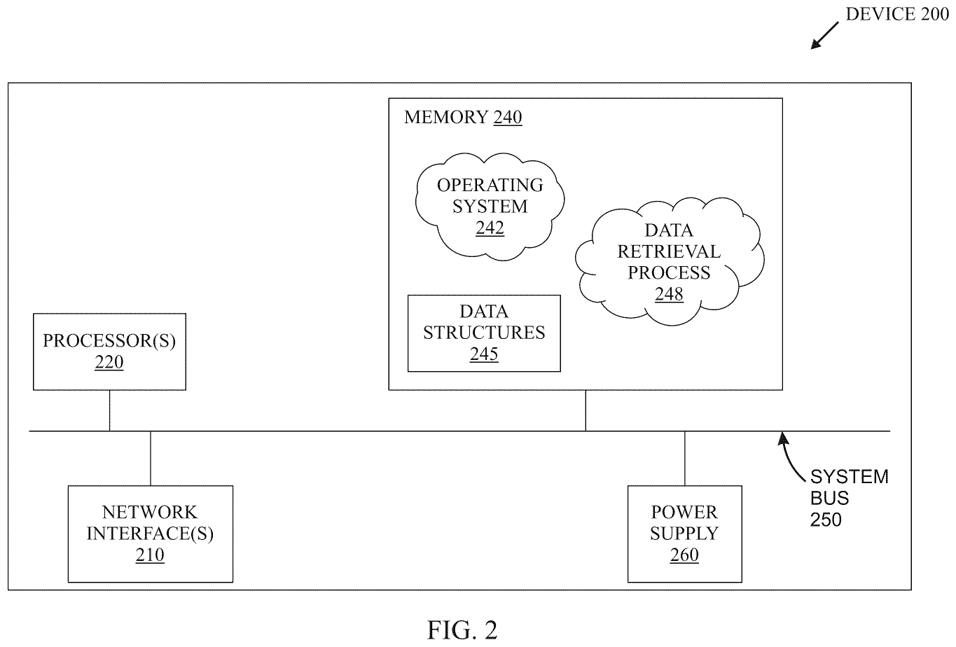

FIG. 2 is a schematic block diagram of an example node/device 200 (e.g., an apparatus) that may be used with one or more implementations described herein, e.g., as any of the nodes or devices shown in FIG. 1 above or described in further detail below. The device 200 may comprise one or more of the network interfaces 210 (e.g., wired, wireless, etc.), at least one processor (e.g., processor(s) 220), and a memory 240 interconnected by a system bus 250, as well as a power supply 260 (e.g., battery, plug-in, etc.).

The network interfaces 210 include the mechanical, electrical, and signaling circuitry for communicating data over physical links coupled to the computing system 100. The network interfaces may be configured to transmit and/or receive data using a variety of different communication protocols. Notably, a physical network interface (e.g., network interfaces 210) may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the implementations described herein. The processor(s) 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processes and/or services executing on the device. These software processes and/or services may comprise one or more functional processes, and on certain devices, a data retrieval process 248, as described herein. Notably, the functional processes, when executed by processor(s) 220, may cause each device 200 to perform the various functions corresponding to the particular device's purpose and general configuration. For example, a router would be configured to operate as a router, a server would be configured to operate as a server, an access point (or gateway) would be configured to operate as an access point (or gateway), a client device would be configured to operate as a client device, and so on.

It will be apparent to those skilled in the art that other processor and memory types, including various computer-readable media, may be used to store and execute program instructions pertaining to the techniques described herein. Also, while the description illustrates various processes, it is expressly contemplated that various processes may be implemented as modules configured to operate in accordance with the techniques herein (e.g., according to the functionality of a similar process). Further, while processes may be shown and/or described separately, those skilled in the art will appreciate that processes may be routines or modules within other processes.

In various implementations, as detailed further below, data retrieval process 248 may include computer executable instructions that, when executed by processor(s) 220, cause device 200 to perform the techniques described herein. For example, data retrieval process 248 may include computer-executable instructions stored on a computer-readable medium that are executable by processor(s) 220 to cause node/device 200 to delegated data retrieval using agentic prompt processing units.

To do so, in some implementations, data retrieval process 248 may utilize machine learning. In general, machine learning is concerned with the design and the development of techniques that take as input empirical data (such as network statistics and performance indicators) and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a, b, c such that the number of misclassified points is minimal. After this optimization phase (or learning phase), model M can be used very easily to classify new data points. Often, M is a statistical model, and the cost function is inversely proportional to the likelihood of M, given the input data.

In various implementations, data retrieval process 248 may employ one or more supervised, unsupervised, or semi-supervised machine learning models. Generally, supervised learning entails the use of a training set of data, as noted above, that is used to train the model to apply labels to the input data. For example, the training data may include sample telemetry that has been labeled as being indicative of an acceptable performance or unacceptable performance. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example machine learning techniques that data retrieval process 248 can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), long short-term memory (LSTM), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for timeseries), random forest classification, or the like.

In further implementations, data retrieval process 248 may also include one or more generative artificial intelligence/machine learning models. In contrast to discriminative models that simply seek to perform pattern matching for purposes such as data access controls, anomaly detection, classification, or the like, generative approaches instead seek to generate new content or other data (e.g., audio, video/images, text, etc.), based on an existing body of training data. For instance, in the context of prompt analysis, data retrieval process 248 may use a generative model to dynamically detect and characterize the tasks carried in a prompt, irrespective of the heterogeneity in the formulation of such prompts and the relative placement of the tasks within the prompt's payload. Example generative approaches can include, but are not limited to, generative adversarial networks (GANs), foundation models such as large language models (LLMs), other transformer models, and the like.

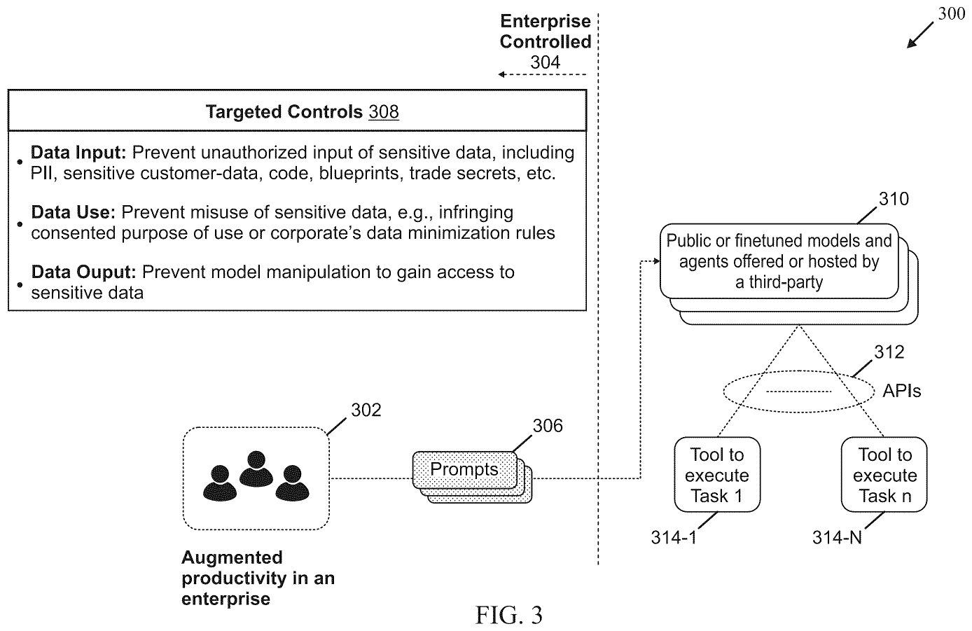

FIG. 3 illustrates an example of an architecture 300 for sending prompts to a remote language model, in accordance with one or more implementations described herein. In architecture 300, users 302 in an enterprise-controlled portion 304 (e.g., network) may send prompts 306 (e.g., queries, etc.) to an external machine learning model (e.g., machine learning model 310).

Typically, prompts 306 may be generated based on input directly from users 302, such as via a chatbot assistant. However, further implementations provide for the use of other programmatic approaches to generate prompts 306, such as by a user selecting a button within a user interface and the underlying program generating a prompt, or the like. In some instances, the executing program may send prompts 306 to machine learning model 310 via one or more application programming interfaces (APIs) and present the results to users 302, accordingly.

Machine learning model 310 may be a public or finetuned language model, such as an LLM, or any other generative AI model configured to process the prompts 306. For example, users 302 such as sales, marketing, customer support, data analytics, engineering, product management, or other personnel in the enterprise may utilize prompts 306 to enhance their productivity.

The increased use of generative AI is posing new challenges to enterprises with respect to data control. More specifically, enterprises need mechanisms that can prevent unauthorized input of sensitive data, the misuse of sensitive data, and/or model manipulation to gain access to sensitive data when utilizing generative AI. Indeed, sensitive data leakage and enterprise policy violations with generative AI are a key concern given that sensitive information may be referenced, used, and/or extracted indirectly (i.e., without explicitly being part of a query).

Further, sensitive information is often needed to complete a task, so personally identifiable information (PII) masking or redaction techniques may not work. In fact, in many cases, it is possible to use model-based analysis to detect the source even after masking or redacting PII. Furthermore, sensitive information may be misused (e.g., for a secondary purpose not compliant with consented purpose of use or by infringing Data Minimization Rules (DMRs)). For instance, specific enterprise controls are often not covered by masking filters and/or redaction techniques. It makes little sense to apply pattern matching controls, such as regular expressions (regex), Exact Data Matching (EDM), or Indexed Document Matching (IDM) techniques to next generation natural language-based systems.

Although many enterprises aim to leverage generative AI, they may also want to observe what tasks are requested by prompts 306 for performance by machine learning model 310. Additionally, users may want to observe and control what data is sent, used, and returned by these third-party systems. Consequently, while the prompts 306, users 302, and any corresponding API calls that they may make may be within the enterprise-controlled portion 304, companies may want to observe and control what data is sent, used, and returned by third-party systems, such as machine learning model 310.

During processing of any of prompts 306, machine learning model 310 may itself leverage one or more APIs 312 to interact with a set of tools 314 (e.g., a first tool 314-1 through nth tool 314-n) to perform any number of discrete tasks. For instance, the set of tools 314 may allow machine learning model 310 to retrieve information from a certain source, as part of its processing. More complex approaches also provide for the set of tools 314 allowing machine learning model 310 to exert some control over an underlying system or device.

Also as shown, from the perspective of the enterprise, there may be a set of targeted controls 308 that the enterprise desires, such as any or all of the following:
Data input—e.g., preventing the unauthorized input of sensitive data, including PII, customer data, code, blueprints, trade secrets, etc.
Data use—e.g., prevent misuse of sensitive data, such as infringing a consented purpose of use or the data minimization rules of the entity
Data output—e.g., preventing manipulation of machine learning model 310 to gain access to the sensitive data

While many online machine learning models (e.g., ChatGPT, etc.) today are able to interpret open-ended prompts and act upon them by generating artifacts based on such understanding, this skill is also not accessible to the enterprise itself. This lack of skill hinders the ability to effectively implement all of the additional controls (e.g., set of targeted controls 308) listed above on the data, before prompts 306 are sent to an external entity from that of the enterprise.

### Data Controls Using Prompt Processing Units

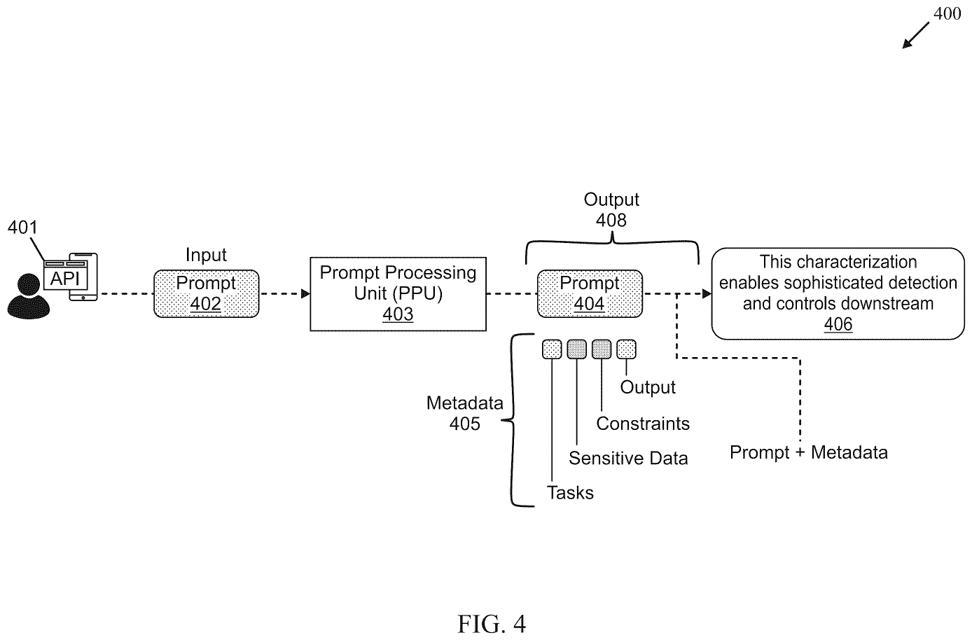

FIG. 4 illustrates an example of an architecture 400 for utilizing PPUs, according to various implementations. In some instances, architecture 400 may be a portion of a data control system that leverages the outputs of PPUs to institute downstream data controls.

As shown, architecture 400 includes a prompt processing unit (PPU 403). A PPU 403 may be a highly efficient processing element that may receive a prompt 402 as an input (e.g., from a user chat interface or an API 401). PPU 403 may parse the query and/or may detect a set of key features from the query carried in a prompt at inference time.

For instance, PPU 403 may detect key features within the prompt 402. These may include the class of tasks requested to an LLM (e.g., “Coding Support”), additional details about the class of tasks detected (e.g., “create a python program”), the data needed to complete the tasks (e.g., a snippet of python code), any constraints applicable to carry out the tasks (e.g., “use the code snippet provided”, or “stick to NumPy”), the desired output upon completion of such tasks (e.g., “stdout”), etc.

A PPU 403 may act as a transparent element, delivering the unmodified prompt 404 augmented with metadata 405 carrying the key features, such as those described above. More specifically, a PPU 403 may systematically distill and characterize prompts, allowing for downstream controls 406 to be applied.

### Automated Data Retrieval

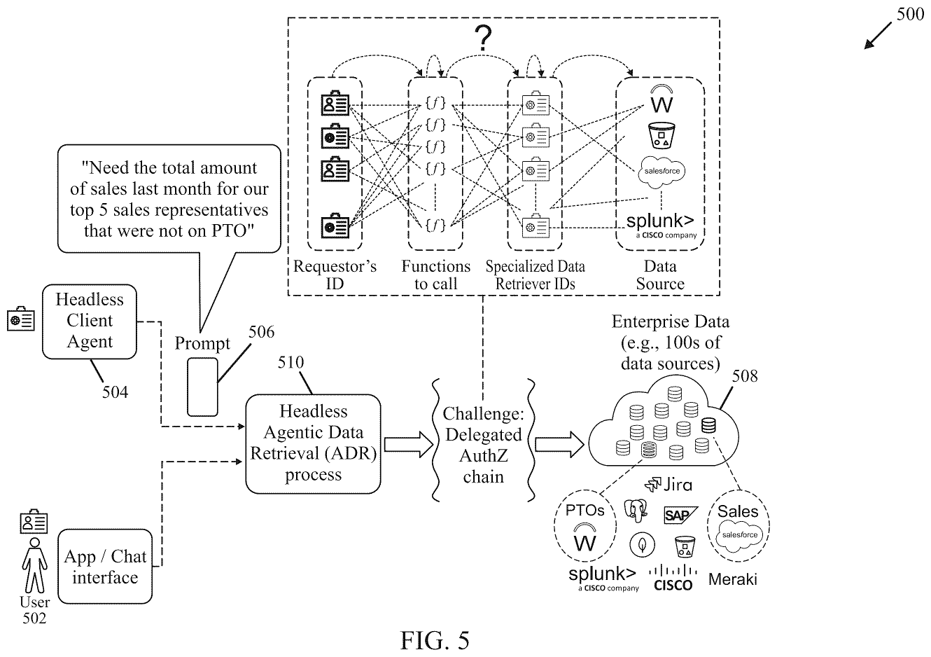

FIG. 5 illustrates an example of an environment 500 within which enterprise data may be utilized as part of complex workflows, in accordance with one or more implementations described herein. Environment 500 may be an environment where an agentic prompt processing unit (APPU) may be deployed to solve a delegated AuthZ chain. As noted above, the ability of conventional LLMs to follow instructions now allows for interactions with tools that can perform tasks such as searching the web, executing code, etc. In addition, agents can be developed to perform complex tasks and workflows by chaining multiple calls to one or more LLMs.

Implementing agents with the capacity to automatically identify, search, retrieve, and use enterprise data as part of complex workflows poses complex challenges for enterprises. This is especially true since existing Identity Provider (IdP) systems, Authentication (AuthN) and Authorization (AuthZ) protocols and servers, and Active Directory (AD) systems fall short while trying to delegate and authorize automated data retrievals performed by headless agents.

For instance, on a user 502 (e.g., a human user with a user ID) or a headless client agent 504 (e.g., with a client agent ID) may generate a prompt 506, where the completion of such prompt by one or more LLMs requires rightful access to one or more enterprise data sources 508 (e.g., Workday and Salesforce in the example). Another headless agent, such as an Agentic Data Retrieval process (e.g., ADR process 510) may receive the prompt, either by working in tandem with the one or more LLMs or by being placed on the path toward the one or more LLMs.

Even if an ADR process may correctly identify the data being requested by the prompt as well as the functions that may become part of a plan and subsequently invoked to retrieve such data, any ADR process may need to dynamically solve a challenging delegated AuthZ chain. First, the part of the chain that maps user and client agent IDs to rightful execution of functions that can be invoked and used by an ADR process (including single function calls and multi-function or nested function calls). Second, many enterprise systems do not even support delegated user-level AuthN/AuthZ (e.g., using OIDC/OAuth2.0 or 2.1), and only support system-to-system integrations, thereby requiring the use of service accounts to access the data in such systems.

The service account-based integrations may introduce additional problems. For example, a function may not map 1:1 to a single API call (e.g., invoking a single method or endpoint) or to a single query (e.g., a single SQL or SPL query), thereby making the problem of discerning whether a pair (user or agent client ID, function ID) may be entitled to use a service account to access data in a system represents a complex challenge. Further, security risks may exist, since data access through a service account that should provide delegated access for a pair (e.g., user or agent client ID, function ID) may lead to privilege escalation issues.

Today, there is void in Identity and Access Management (IAM) standards and methods enabling companies to automatically detect, map, and restrict a set of pairs (user or agent client ID, function ID) identified by an ADR process, to service account IDs that can be rightfully used by one or more data retrievers, which might be specialized to retrieve the desired data from specific enterprise data resources and provide such data to one or more LLMs.

Further, conventional approaches provide a standardized system and protocol for life-cycle management of users and groups enabling to keep them continuously synchronized across different Apps and domains (e.g., at sync intervals in the timeframe of 40 minutes or more). However, in practice things are way more complex for an enterprise. For instance, many systems do not support delegated user-level AuthN/AuthZ integrations, and hence service accounts need to be added to the picture, for which there are no standardized delegation mechanisms for headless function calling, even after the syncs.

Indeed, existing techniques fall short when delegated AuthZ chains involve agents, functions, service accounts and LLMs, hence requiring a Do It Yourself (DIY) model to solve for the missing elements in existing IAM stacks. In addition, the number of data sources used within an enterprise may be in the order of hundreds or even thousands, thereby making any DIY model and partial or full-mesh system-to-system syncs even more challenging. Even if in the future, centralized solutions become the center of gravity for user and group syncs (e.g., using Okta), the problem of automatically solving delegated AuthZ chains to access enterprise data involving agents, functions, service accounts, and LLMs persists, thus necessitating a DIY model.

### Delegated Data Retrieval Using Agentic Prompt Processing Units

In contrast, the techniques herein may facilitate delegated data retrieval using Agentic Prompt Processing Units (APPUs). These techniques introduce a novel delegated data retrieval technique that uses APPUs as the ADR process. The techniques introduced herein enable new AuthZ lookups and automated resolution involving service accounts associated to data retrievers, thereby solving the complex delegated AuthZ chain described above.

Specifically, according to one or more implementations of the disclosure, a device may parse a prompt to be submitted to a language model to identify data being requested by the prompt, functions associated with retrieving the data, and an access token carrying a corresponding identity of a requestor of the prompt. The device may perform an authorization lookup in an identity and access management matrix that contains a solution for a delegated authorization chain using the access token and the functions associated with retrieving the data. The device may retrieve, responsive to a successful authorization lookup, the data being requested by the prompt using a plan formulated based on the solution for the delegated authorization chain. The device may send the prompt and retrieved data to the language model to prepare a response to the requestor of the prompt.

Illustratively, the techniques described herein may be performed by hardware, software, and/or firmware, such as in accordance with data retrieval process 248, which may include computer executable instructions executed by the processor(s) 220 (or independent processor of network interfaces 210) to perform functions relating to the techniques described herein.

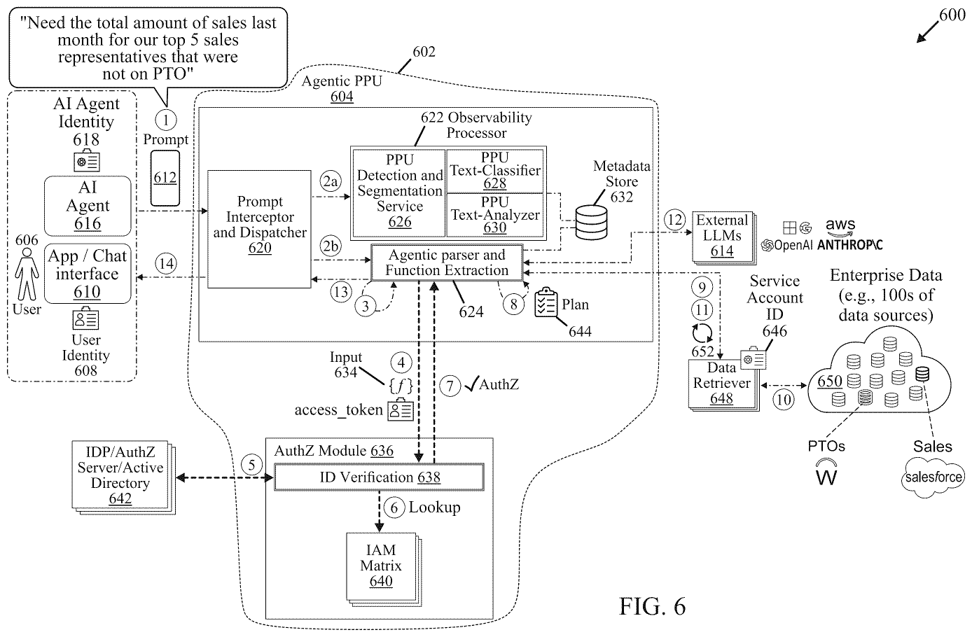

Operationally, FIG. 6 illustrates an example of an environment 600 incorporating the system 602 to facilitate delegated data retrieval, in accordance with one or more implementations described herein. The system 602 may be configured to manage new AuthZ lookups and automated AuthZ resolution involving service accounts associated to data retrievers.

The techniques introduced herein, enable an Agentic Prompt Processing Unit (APPU 604) to automatically detect, map, and restrict a set of pairs (e.g., user or agent client ID, function ID, etc.) identified after processing an input prompt, to one or more service account IDs that can be rightfully used by one or more data retrievers to get the data requested in an input prompt. These techniques can be leveraged by companies to dynamically solve delegated AuthZ chains, including agentic scenarios.

In various implementations, a user 606, with user identity 608 may use an application or chat interface 610 to generate a prompt 612 to be processed and completed by one of more Large Language Models (LLMs 614). Prompt 612 may also be generated by a headless client, e.g., AI agent 616, with AI agent identity 618.

A prompt 612 generated either by user 606 or an AI agent 616 may reach or be intercepted by APPU 604. More specifically, prompts (e.g., prompt 612) may be either intercepted or received by APPU 604, which might be reachable as part of a software as a service (SaaS) deployment provisioned by a solution provider, or it might be deployed on premise as part of the company's infrastructure. For instance, some enterprises have already developed multiple ways to intercept and transparently create copies of prompts (e.g., prompt 612), including plugins for Cisco WebEx, Slack, Kong, python SDKs providing wrappers around widely used libraries, including OpenAI, Azure OpenAI and Langchain, as well as npm libraries for React.

In various implementations, AuthZ lookups and the resolution of delegated AuthZ chains may be performed in environment 600 by progressing through a set of steps. For example, in step one a prompt 612 generated by a user 606 and/or an AI agent 616 may reach or be intercepted by a prompt interceptor and dispatcher 620.

In a second step, prompt interceptor and dispatcher 620 may receive and simultaneously dispatch the prompt 612 both to an observability processor 622, and an agentic parser and function extraction 624 in steps (step 2a), and (step 2b), respectively. Observability processor 622 may comprise a PPU detection and segmentation service 626, a PPU text-classifier 628, and a PPU text-analyzer 630 as well as a metadata store 632.

In step three, agentic parser and function extraction 624 may parse the prompt received, and it may automatically identify the data being requested by prompt 612 as well as the set of functions {f} that would be required to retrieve such data. To this end, agentic parser and function extraction 624 may utilize automated data to function mapping using APPUs. Agentic parser and function extraction 624 may also identify an access token as part of the metadata received in step 2b, and from the token, it may extract the identity of the corresponding requestor (e.g., user identity 608 or AI agent identity 618).

In step four, the set of functions {f} identified in step 3, along with the access token and the requestor's identity may be used as input 634 to an AuthZ module 636. AuthZ module 636 may comprise an ID verification process 638 as well as a set of IAM matrices 640.

Upon receiving an AuthZ request from agentic parser and function extraction 624 in step four, ID verification process 638 may use various means to verify the authenticity and validity of the access token received at step five. This may entail querying the company's IdP and/or AuthZ server 642, which may also use or be linked to one or more active directory servers. In various implementations, this may entail token introspection techniques, especially, for opaque tokens.

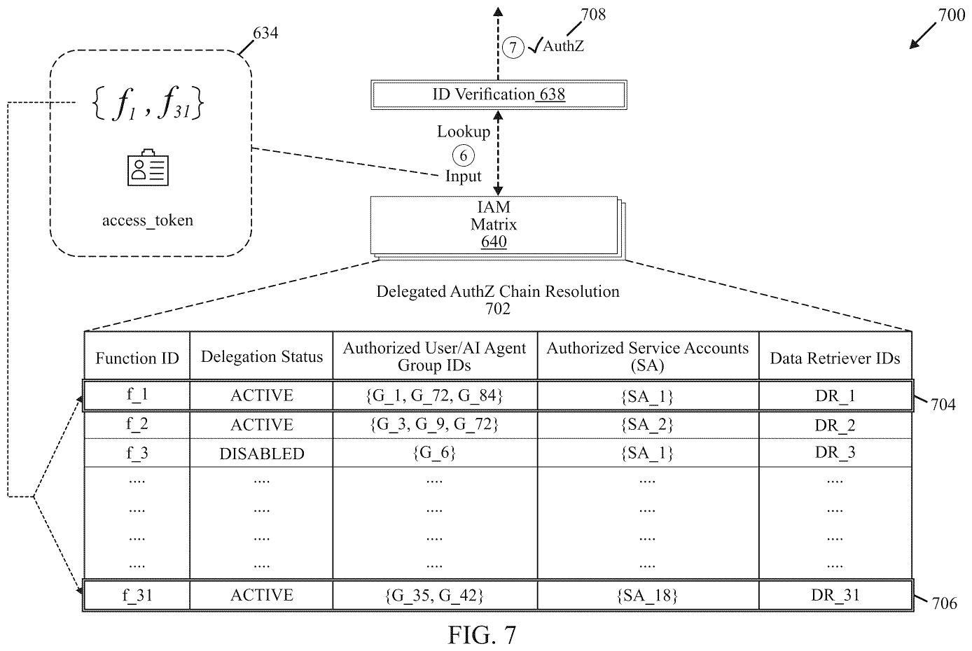

Once the token and the identity carried along with prompt 612 are verified and validated, ID verification process 638 may perform an AuthZ lookup, at step six, using one or more IAM matrices of the set of IAM matrices 640. An example embodiment of an IAM matrix and its contents for solving delegated AuthZ chains involving service accounts is described in detail later using system 700 in FIG. 7.

After the lookup process, the delegated AuthZ chain is analyzed and resolved, and the process may proceed to step seven. Here, if at least one of the data retrievals requested in prompt 612 is denied (e.g., when one of the functions in the set {f} cannot be rightfully executed), then ID verification process 638 may inform agentic parser and function extraction 624 of such denial, which in turn may inform the requestor via prompt interceptor and dispatcher 620. If on the contrary, all the data requested is authorized (e.g., when all the functions in the set {f} can be rightfully executed), then ID verification process 638 may inform the agentic parser and function extraction 624 that the AuthZ was granted, which in turn may proceed to step eight.

Upon receiving an AuthZ OK in step seven, agentic parser and function extraction 624 may create a plan 644 at step eight. The plan 644 may include a list of ordered steps to sequentially invoke and execute the corresponding set of functions {f} and rely on the service accounts 646 required for the data retrievals, as identified from an IAM matrix of the set of IAM matrices 640.

In step nine, agentic parser and function extraction 624 may now start executing plan 644, by invoking a first specialized data retriever 648 (e.g., embodied as a lambda function with a data connector and runtime, a Model Context Protocol (MCP) client working in tandem with an MCP server, or as yet another agent). Such a data retriever may be able to use the service accounts 646 identified as a result of the lookup performed in step six. In step ten, a first specialized data retriever 648 may now get the corresponding data from the various enterprise data sources 650, as determined by the one or more functions identified in the set {f}.

In step eleven, the data obtained by data retriever 648 may be sent back to agentic parser and function extraction 624. Agentic parser and function extraction 624 may now observe the state of the execution of plan 644 and sequentially invoke a next specialized data retriever from the set of data retrievers identified in step six. Agentic parser and function extraction 624 may repeat steps nine, ten, and/or eleven as many times as needed using loop 652, to cover the various data retrievers identified and complete the execution of plan 644. In some cases, the execution of the initial plan may fail (e.g., some steps may not be completed, some data might not be retrieved due to a connectivity failure, or an excessive delay in the response of a function call, etc.). In such cases, agentic parser and function extraction 624 may be endowed with mechanisms to adapt and replan, leading to variants of steps nine, ten, and/or eleven and the adaptation of loop 652.

Once the data retrievals are completed, agentic parser and function extraction 624 may, at step twelve, request one or more of the LLMs 614 to compile and prepare a final response to the original requestor (e.g., user 606 and/or AI agent 616). At step thirteen, the final response may be forwarded to prompt interceptor and dispatcher 620. At step fourteen, prompt interceptor and dispatcher 620 may now send the prompt completion to the corresponding requestor. Alternatively, step twelve may also be performed by specialized local LLMs, without the need to involve external LLMs 614. This case may be particularly relevant for organizations that require data retrievals and processing by AI models using private data centers and/or on-premises infrastructure, so that they do not expose any data to external systems.

FIG. 7 illustrates an example of a system 700 for solving a delegated AuthZ chain 702 using identity and access management matrices (e.g., the set of IAM matrices 640), in accordance with one or more implementations described herein. As described above, a lookup process in step six (e.g., step six of FIG. 6) may use as an input 634 a set of functions identified in step three of FIG. 6 (e.g., {f1, f31}), and an already verified and validated access token carrying the requestor's ID (e.g., user identity 608 or AI agent identity 618).

The lookup request in step six may be sent to, and processed by, one or more of the IAM matrices from the set of IAM matrices 640. Such matrices may capture the various mappings required to automatically solve a delegated AuthZ chain involving diverse functions that need to be called, authorized user and/or AI agent IDs, authorized service accounts, data retriever IDs, and the status of such delegation.

For instance, in various implementations, the delegation status both for f1 and f31 may remain active. The lookup process may now check if the user identity 608 or the AI agent identity 618 belongs to the groups G_1 OR G_72 OR G_84 for f_1 and if it also belongs to G_35 OR G_42 for f_31. Note that different techniques may be used to accelerate this search. If the user identity 608 or the AI agent identity 618 belongs to any of the authorized groups for functions f1, and f31, simultaneously, then both an authorized service account and a data retriever ID may be identified in rows 704, and 706, respectively. In such case, an AuthZ OK response 708 may be sent back in step seven.

Overall, system 700 illustrates an AuthZ mechanism using an APPU that facilitates new identity and access controls solving delegated AuthZ chains in scenarios involving functions calls, agents, service accounts, and data retrievers. It will be apparent to those skilled in the art that other possible implementations and embodiments are feasible, hence the above descriptions are to be taken only by way of example and not to otherwise limit the scope of the implementations herein.

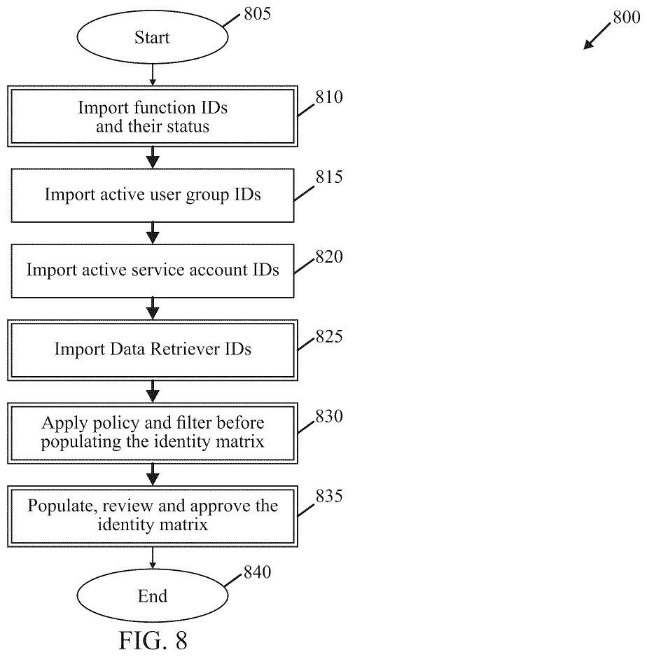

FIG. 8 illustrates an example of a simplified procedure for populating and approving an IAM matrix enabling automated delegated AuthZ chain resolution, in accordance with one or more implementations described herein. For example, a non-generic, specifically configured device (e.g., device 200), may perform procedure 800 (e.g., a method) by executing stored instructions (e.g., data retrieval process 248).

The procedure 800 may start at step 805, and continues to step 810, where, as described in greater detail above, the device (e.g., a controller, processor, etc.) may import function IDs and their status.

At step 815 a device may import active user group IDs. At step 820, as detailed above, a device may import active service account IDs. At step 825, a device may import data retriever IDs.

At step 830, as detailed above, a device may apply a policy and filter before populating the identity matrix. At step 835, a device may populate, review, and/or approve the identity matrix.

Procedure 800 then ends at step 840.

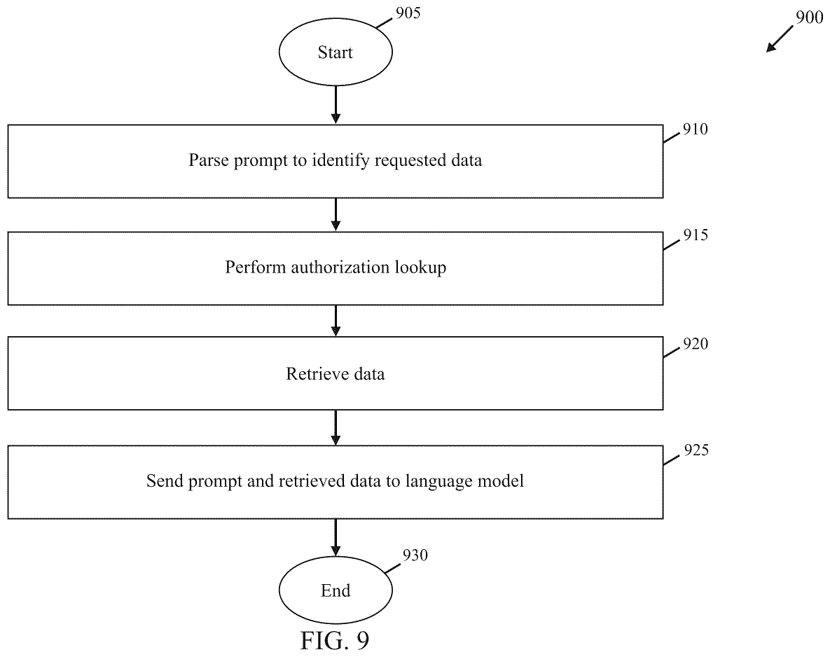

FIG. 9 illustrates an example of a simplified procedure for delegated data retrieval using agentic prompt processing units, in accordance with one or more implementations described herein. For example, a non-generic, specifically configured device (e.g., device 200), may perform procedure 900 (e.g., a method) by executing stored instructions (e.g., data retrieval process 248).

The procedure 900 may start at step 905, and continues to step 910, where, as described in greater detail above, the device (e.g., a controller, processor, etc.) may parse a prompt to be submitted to a language model. Specifically, the prompt may be parsed to identify information associated with the prompt such as: the data being requested by the prompt, functions associated with retrieving the data, and/or an access token carrying a corresponding identity of a requestor of the prompt.

In various implementations, the corresponding identity of the requestor of the prompt may be extracted from the access token. The access token and/or the requestor of the prompt may be validated.

At step 915, the device may perform an authorization lookup in an identity and access management matrix that contains a solution for a delegated authorization chain. The lookup may be performed using the access token and/or the functions associated with retrieving the data.

The identity and access management matrix may include one or more of function identifications and their statuses, authorized user group identifications, authorized service account identifications, and/or data retriever identifications. In various implementations, performing the authorization lookup may include checking whether the corresponding identity of the requestor of the prompt belongs to an authorized user group identification associated with the functions associated with retrieving the data as specified in the identity and access management matrix.

Components may be imported to the identity and access management matrix. The components may include function identifications and their statuses, authorized user group identifications, authorized service account identifications, and data retriever identifications. In various implementations, a policy and/or a filter may be applied to the components before populating the components into the identity and access management matrix.

At step 920, the device may retrieve, responsive to a successful authorization lookup, the data being requested by the prompt. The retrieval may be performed using a plan formulated based on the solution for the delegated authorization chain.

The plan may include instructions executable to sequentially invoke and execute a corresponding set of authorized functions. The plan may rely on and/or leverage corresponding authorized service accounts as identified in the identity and access management matrix. In various implementations, the execution of the plan may be monitored and/or the plan may be adapted to detected retrieval failures (e.g., to overcome or avoid retrieval failures).

In various implementations, the identity and access management matrix may be utilized to identify a service account identification authorized to be utilized by a data retriever to the data.

At step 925, the device may send the prompt and retrieved data to the language model in order for the language model to prepare a response to the requestor of the prompt.

Procedure 900 then ends at step 930.

It should be noted that while certain steps within procedure 800 and/or procedure 900 may be optional as described above, the steps shown are merely examples for illustration, and certain other steps may be included or excluded as desired. Further, while a particular order of the steps is shown, this ordering is merely illustrative, and any suitable arrangement of the steps may be utilized without departing from the scope of the implementations herein.

The techniques described herein, therefore, introduce a delegated data retrieval technique using Agentic Prompt Processing Units (APPUs). The techniques introduced herein enable new AuthZ lookups and automated resolution solving complex delegated AuthZ chains. These techniques may facilitate the resolution of complex delegated AuthZ chains enabling rightful agentic data retrievals in scenarios where user-level AuthN/AuthZ is not an option. Further, these techniques may provide automatic and dynamic mapping involving a set of potential functions to be called, authorized user and/or AI agent IDs, authorized service accounts, delegated data retriever IDs, and the status of such delegations

While there have been shown and described illustrative implementations that provide for delegated data retrieval using APPUs, it is to be understood that various other adaptations and modifications may be made within the intent and scope of the implementations herein. In addition, while certain processes are shown, other suitable processes may be used, accordingly.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true spirit and scope of the implementations herein.

What is claimed is:

1. A method, comprising:
parsing, by a device, a prompt to be submitted to a language model to identify data being requested by the prompt, functions associated with retrieving the data, and an access token carrying a corresponding identity of a requestor of the prompt;
performing, by the device, an authorization lookup in an identity and access management matrix that contains a solution for a delegated authorization chain using the access token and the functions associated with retrieving the data;
retrieving, by the device and responsive to a successful authorization lookup, the data being requested by the prompt using a plan formulated based on the solution for the delegated authorization chain; and
sending, by the device, the prompt and retrieved data to the language model to prepare a response to the requestor of the prompt.

2. The method as in claim 1, further comprising:
extracting the corresponding identity of the requestor of the prompt from the access token.

3. The method as in claim 2, further comprising:
validating the access token and the requestor of the prompt.

4. The method as in claim 1, wherein the identity and access management matrix includes one or more of function identifications and their statuses, authorized user group identifications, authorized service account identifications, or data retriever identifications.

5. The method as in claim 4, wherein the plan includes instructions to sequentially invoke and execute a corresponding set of authorized functions and relying on corresponding authorized service accounts as identified in the identity and access management matrix.

6. The method as in claim 4, wherein performing the authorization lookup includes checking whether the corresponding identity of the requestor of the prompt belongs to an authorized user group identification associated with the functions associated with retrieving the data as specified in the identity and access management matrix.

7. The method as in claim 1, further comprising:
utilizing the identity and access management matrix to identify a service account identification authorized to be utilized by a data retriever to the data.

8. The method as in claim 1, further comprising:
importing components to the identity and access management matrix including function identifications and their statuses, authorized user group identifications, authorized service account identifications, and data retriever identifications.

9. The method as in claim 8, further comprising:
applying a policy and a filter before populating those components into the identity and access management matrix.

10. The method as in claim 1, further comprising:
monitoring an execution of the plan; and
adapting the plan to detected retrieval failures.

11. An apparatus, comprising:
one or more network interfaces;
a processor coupled to the one or more network interfaces and configured to execute one or more processes; and
a memory configured to store a process that is executable by the processor, the process when executed configured to:
parse a prompt to be submitted to a language model to identify data being requested by the prompt, functions associated with retrieving the data, and an access token carrying a corresponding identity of a requestor of the prompt;
perform an authorization lookup in an identity and access management matrix that contains a solution for a delegated authorization chain using the access token and the functions associated with retrieving the data;
retrieve, responsive to a successful authorization lookup, the data being requested by the prompt using a plan formulated based on the solution for the delegated authorization chain; and
send the prompt and the data to the language model to prepare a response to the requestor of the prompt.

12. The apparatus as in claim 11, wherein the process when executed is further configured to:
extract the corresponding identity of the requestor of the prompt from the access token.

13. The apparatus as in claim 12, wherein the process when executed is further configured to:
validate the access token and the requestor of the prompt.

14. The apparatus as in claim 11, wherein the identity and access management matrix includes one or more of function identifications and their statuses, authorized user group identifications, authorized service account identifications, or data retriever identifications.

15. The apparatus as in claim 14, wherein the plan includes instructions to sequentially invoke and execute a corresponding set of authorized functions and relying on corresponding authorized service accounts as identified in the identity and access management matrix.

16. The apparatus as in claim 14, wherein performance of the authorization lookup includes checking whether the corresponding identity of the requestor of the prompt belongs to an authorized user group identification associated with the functions associated with retrieving the data as specified in the identity and access management matrix.

17. The apparatus as in claim 11, wherein the process when executed is further configured to:
utilize the identity and access management matrix to identify a service account identification authorized to be utilized by a data retriever to the data.

18. The apparatus as in claim 11, wherein the process when executed is further configured to:
import components to the identity and access management matrix including function identifications and their statuses, authorized user group identifications, authorized service account identifications, and data retriever identifications.

19. The apparatus as in claim 18, wherein the process when executed is further configured to:
apply a policy and a filter before populating the components into the identity and access management matrix.

20. A tangible, non-transitory, computer-readable medium storing program instructions that cause a device to execute a process comprising:
parsing a prompt to be submitted to a language model to identify data being requested by the prompt, functions associated with retrieving the data, and an access token carrying a corresponding identity of a requestor of the prompt;
performing an authorization lookup in an identity and access management matrix that contains a solution for a delegated authorization chain using the access token and the functions associated with retrieving the data;
retrieving, responsive to a successful authorization lookup, the data being requested by the prompt using a plan formulated based on the solution for the delegated authorization chain; and
sending the prompt and the data to the language model to prepare a response to the requestor of the prompt.
